(19) United States
(12) Patent Application Publication
(10) Pub. No.: US 2025/0244272 A1
(43) Pub. Date: Jul. 31, 2025

(54) METHOD FOR DETECTING SURFACE DEFECT OF THERMAL CUP, SYSTEM THEREOF, DEVICE AND MEDIUM

(71) Applicant: Zhejiang Normal University, Jinhua City (CN)

(72) Inventors: Dongyun WANG, Jinhua City (CN); Ruidi WENG, Jinhua City (CN); Xiangxiang WANG, Jinhua City (CN); Zeyu YU, Jinhua City (CN); Zhecheng LUO, Jinhua City (CN)

(21) Appl. No.: 18/937,682

(22) Filed: Nov. 5, 2024

(30) Foreign Application Priority Data
Jan. 31, 2024 (CN) 202410139217.4

(51) Int. Cl. G01N 25/72; G06T 5/90; G06T 7/00; G06T 7/11; G06T 7/136

(52) U.S. Cl. CPC G01N 25/72; G06T 5/90; G06T 7/0004; G06T 7/11; G06T 7/136; G06T 2207/30136

(57) ABSTRACT

A method for detecting a surface defect of a thermal cup, a system thereof, a device and a medium are provided. The method includes: acquiring thermal cup images from different angles, and preprocessing thermal cup images to generate enhanced thermal cup images; performing convolution operation for a first-order derivative of a Gaussian function on the enhanced thermal cup images to determine first filtered images; and determining defect regions according to the first filtered images and the thermal cup images by using a threshold segmentation method based on a bilinear interpolation and a second-order derivative of the Gaussian function. The set parameters are adjusted based on a gradient change and the current illumination environment. The defect regions include a final pit defect region, an upper side polishing print defect region and a lower side polishing print defect region.

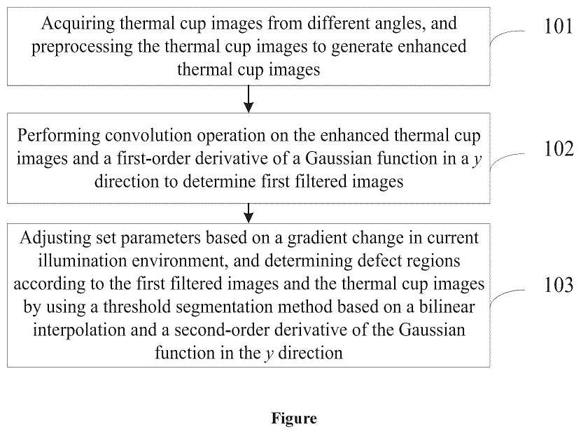

### CROSS-REFERENCE TO RELATED APPLICATION

This patent application claims the benefit of and priority to Chinese Patent Application No. 2024101392174, filed with the Chinese Patent Office on Jan. 31, 2024, which is hereby incorporated by reference herein in its entirety.

### TECHNICAL FIELD

The present disclosure relates to the field of detection of surface defects of thermal cups, and in particular to a method for detecting a surface defect of a thermal cup, a system thereof, a device and a medium.

### BACKGROUND

A stainless steel thermal cup is excellent in thermal insulation and cold insulation performance, which can effectively keep the temperature of liquid for a certain period of time. Therefore, a stainless steel thermal cup has become a necessary daily product for many people, and in turn, the manufacturing and the quality of a thermal cup has played a very important role in promoting the whole manufacturing industry.

Whether the appearance of a stainless steel thermal cup is smooth and beautiful and whether the hand feeling is satisfactory depend to a great extent on the polishing degree of the external surface of the thermal cup during processing and whether there is any bump in the manufacturing process.

However, in actual production, in the current large number of situations where the cylindrical shell of a thermal cup is polished manually or with simple mechanical assistance, poor polishing is inevitable. In the subsequent transportation and processing, it is inevitable that some cup bodies will collide with other hard objects, thus resulting in pit defects.

In visual appearance the two types of defects are shown as horizontal strip concave regions on smooth surfaces. The two types of defects seriously affect the beauty and experience, which easily have a great impact on subsequent sales. Therefore, how to identify the two types of defects in time and effectively is an important part of testing the quality of a thermal cup.

At present, the surface defects of a thermal cup are mostly detected by human eyes, and some shallow pits and shallow polishing prints can only be clearly seen by human eyes after the cup body and the light source form a specified angle, which also leads to the low efficiency of manual detection and many missed detections.

Nowadays, there are indeed a large number of mechanical devices improved in the polishing process of thermal cups, which can improve the occurrence of poor polishing to a certain extent, but cannot completely avoid the occurrence of poor polishing. The manual detection in the later stage is still required.

Although there are also vision algorithms about poor polishing and pit defects, there are two problems. The first problem is that the vision algorithm for poor polishing and pit defects of thermal cups has not been studied in detail yet. The second problem is that the algorithm for poor polishing or pits on the surface of objects shot by an area-array camera instead of a linear camera has not been studied in detail yet.

At the same time, there is not only a type of defects on the surface of the thermal cup, and the existing vision algorithm needs to change the lighting method, camera configuration, etc. again for every time the algorithm detecting a type of defects. Therefore, the algorithm cannot detect all possible defects within the shooting range, the detection efficiency is low, and the detection cost is high.

### SUMMARY

The present disclosure aims to provide a method for detecting a surface defect of a thermal cup, a system thereof, a device and a medium, so as to solve the problems that the existing visual detection method is low in detection efficiency and high in detection cost.

In order to achieve the above objects, the present disclosure provides the following scheme.

The present disclosure relates to a method for detecting a surface defect of a thermal cup, including:
acquiring thermal cup images from different angles, and preprocessing the thermal cup images to generate enhanced thermal cup images;
performing convolution operation on the enhanced thermal cup images and a first-order derivative of a Gaussian function in the y direction to determine first filtered images; and
adjusting set parameters based on a gradient change in the current illumination environment, and determining defect regions according to the first filtered images and the thermal cup images by using a threshold segmentation method based on a bilinear interpolation and a second-order derivative of the Gaussian function in the y direction; wherein the defect regions include a final pit defect region, an upper side polishing print defect region and a lower side polishing print defect region.

In some embodiments, the preprocessing the thermal cup images to generate enhanced thermal cup images includes:
determining stretching of different brightness regions of the thermal cup images according to an adjustable gamma correction parameter, enhancing the contrast between pixels in a gray scale range, and determining the thermal cup images subjected to gamma conversion; and
filtering the thermal cup images subjected to gamma conversion according to an adjustable contrast enhancement parameter to generate the enhanced thermal cup images.

In some embodiments, the adjusting set parameters based on a gradient change in the current illumination environment, and determining defect regions according to the first filtered images and the thermal cup images by using a threshold segmentation method based on a bilinear interpolation and a second-order derivative of the Gaussian function in the y direction, includes:
processing the first filtered images by using the threshold segmentation method based on the bilinear interpolation to determine preliminary pit defect regions;
adjusting a first set parameter based on the gradient change in the current illumination environment, and screening the preliminary pit defect regions to determine a final pit defect region;
performing discrete approximate Gaussian filtering on the enhanced thermal cup images to determine filtered images;
performing convolution operation on the filtered images and the second-order derivative of the Gaussian function in they direction to determine second filtered images;
adjusting a second set parameter based on the gradient change in the current illumination environment, and determining preliminary trapezoidal surface polishing print defect regions according to the second filtered images;
determining the upper side polishing print defect region according to the preliminary trapezoidal surface polishing print defect regions; and
determining the lower side polishing print defect region according to the thermal cup images.

In some embodiments, the processing the first filtered images by using the threshold segmentation method based on the bilinear interpolation to determine preliminary pit defect regions includes:
setting the first filtered image as a plane, searching for pixels and sub-pixels in the plane whose gray values are an adjustable set parameter t by using the threshold segmentation method based on the bilinear interpolation, and determining pixel coordinates and sub-pixel coordinates; and
converting the pixel coordinates and the sub-pixel coordinates into closed contours by using a Bresenham's line algorithm; wherein each closed contour is a preliminary pit defect region.

In some embodiments, the adjusting a first set parameter based on the gradient change in the current illumination environment, and screening the preliminary pit defect regions to determine a final pit defect region, includes:
adjusting the first set parameter based on the gradient change in the current illumination environment; wherein the first set parameter includes a first column coordinate, a second column coordinate, a first region area, a second region area, a first region gray standard deviation and a second region gray standard deviation; and
determining the preliminary pit defect region with a center column coordinate between the first column coordinate and the second column coordinate, a region between the first region and the second region, and a region gray standard deviation between the first region gray standard deviation and the second region gray standard deviation as the final pit defect region.

In some embodiments, the determining the upper side polishing print defect region according to the preliminary trapezoidal surface polishing print defect regions includes:
extracting upper side polishing print features of the preliminary trapezoidal surface polishing print defect regions, and determining polishing print defect region images containing the upper side polishing print features;
performing mean filtering processing on the polishing print defect region images containing the upper side polishing print features to determine the polishing print defect region images subjected to mean filtering;
performing convolution operation on the polishing print defect region images subjected to mean filtering and the second-order derivative of the Gaussian function in the y direction to determine convoluted polishing print defect region images; and
screening the convoluted polishing print defect region image whose gray value is within a gray value range, and determining the upper side polishing print defect region.

In some embodiments, the determining the lower side polishing print defect region according to the thermal cup images includes:
stretching the thermal cup images to determine the stretched thermal cup images;
performing the discrete approximate Gaussian filtering on the stretched thermal cup images to determine the thermal cup images subjected to Gaussian filtering;
performing the convolution operation on the thermal cup images subjected to Gaussian filtering and the first-order derivative of the Gaussian function in the y direction to determine the convolved thermal cup images;
screening the convolved thermal cup image whose gray value is within a gray value range, and determining the lower side polishing print defect region.

A system for detecting a surface defect of a thermal cup is provided, including:
a preprocessing module, configured to acquire thermal cup images from different angles, and preprocess the thermal cup images to generate enhanced thermal cup images;
a convolution module, configured to perform convolution operation on the enhanced thermal cup images and a first-order derivative of a Gaussian function in the y direction to determine first filtered images; and
a defect region determining module, configured to adjust set parameters based on a gradient change in the current illumination environment, and determine defect regions according to the first filtered images and the thermal cup images by using a threshold segmentation method based on a bilinear interpolation and a second-order derivative of the Gaussian function in the y direction; wherein the defect regions include a final pit defect region, an upper side polishing print defect region and a lower side polishing print defect region.

An electronic device is provided, including a memory, a processor, and a computer program, stored on the memory, wherein the computer program, when executed by the processor, causes the electronic device to perform the method for detecting the surface defect of the thermal cup above.

A computer-readable storage medium having a computer program stored therein is provided, wherein the computer program, when executed by a processor, implements the method for detecting the surface defect of the thermal cup above.

According to the specific embodiments provided by the present disclosure, the present disclosure discloses the following technical effects. In the embodiment of the present disclosure, the image contrast is enhanced by enhancing the thermal cup images from different angles, the defects in the images are accurately located by using a threshold segmentation method based on a bilinear interpolation, and convolution operation is performed on the images by using the first-order derivative and the second-order derivative of the Gaussian function in the y direction to amplify the defect features for edge detection, so that the detection efficiency is improved. In addition, according to the present disclosure, set parameters are adjusted based on a gradient change in the current illumination environment to detect all possible defects within the shooting range. When detecting different types of defects, it is not necessary to change the lighting method, camera configuration, etc. again. Therefore, the detection cost is reduced.

### BRIEF DESCRIPTION OF THE DRAWINGS

In order to explain the embodiments of the present disclosure or the technical schemes in the prior art more clearly, the drawings that need to be used in the embodiments will be briefly introduced hereinafter. Obviously, the drawings in the following description are only some embodiments of the present disclosure. For those skilled in the art, other drawings can be obtained according to these drawings without creative labor.

FIGURE is a flowchart of a method for detecting a surface defect of a thermal cup according to the present disclosure.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

The present disclosure aims to provide a method for detecting a surface defect of a thermal cup, a system thereof, a device and a medium, which improve the low detection efficiency and reduce the detection cost.

In order to make the above objects, features and advantages of the present disclosure more obvious and understandable, the present disclosure will be explained in further detail with reference to the drawings and detailed description hereinafter.

### Embodiment 1

As shown in FIGURE, the present disclosure provides a method for detecting a surface defect of a thermal cup, which includes steps 101-103.

In step 101, thermal cup images from different angles are acquired, and the thermal cup images are preprocessed to generate enhanced thermal cup images.

In step 102, convolution operation is performed on the enhanced thermal cup images and a first-order derivative of a Gaussian function in they direction to determine first filtered images.

In step 103, set parameters are adjusted based on a gradient change in the current illumination environment, and defect regions are determined according to the first filtered images and the thermal cup images by using a threshold segmentation method based on a bilinear interpolation and a second-order derivative of the Gaussian function in the y direction; wherein the defect regions include a final pit defect region, an upper side polishing print defect region and a lower side polishing print defect region.

In practical application, step 101 specifically includes: determining stretching of different brightness regions of the thermal cup images according to an adjustable gamma correction parameter, enhancing the contrast between pixels in a gray scale range, and determining thermal cup images subjected to gamma conversion; and filtering the thermal cup images subjected to gamma conversion according to an adjustable contrast enhancement parameter to generate the enhanced thermal cup images.

Furthermore, there are two industrial cameras that are parallel to the plane where the thermal cup is located, shooting the upper and lower side surfaces of the thermal cup, respectively. The upper side surface should include the trapezoidal transition surface of the thermal cup. In order to shoot all the surfaces of the thermal cup completely, the thermal cup can be rotated at different angles around the rotation axis of the thermal cup and then is shot. When the camera is working, the ambient light source is provided by a fan-shaped light source with a fan-shaped area enough to cover the thermal cup, so as to minimize the surface exposure of the thermal cup. It is taken into account that in practical application, in the premise of not changing the configuration of the fan-shaped light source, the expression form and the exposure degree of the polishing print on each surface are different. Therefore, in practical use, it is necessary to adjust different operation parameters for different surfaces shot by the camera, such as trapezoidal surfaces and sides, so as to achieve the best screening effect.

It is necessary to predefine two adjustable parameters γ and f, and the purpose of each parameter will be explained in detail later. After the image is acquired, the following conversion is performed on each pixel of the image:

$${V}_{out} = {V}_{i n}^{γ} \qquad ( 1 )$$

where Vₒᵤₜ and Vᵢₙ represent the image before and after processing, respectively, and γ is the gamma correction parameter. By adjusting the size of γ, the image can be stretched in different brightness regions, and then the contrast between pixels in the specified gray range can be enhanced. After completing the gamma conversion, mean filtering is performed on the image. Finally, the filtered image is processed by pixels as follows:

$$res = round ( ( orig - mean ) \times f + o r i g \qquad ( 2 )$$

where res is the pixel value after process of the above formula, orig is the image pixel before the conversion, mean is the pixel value of the filtered image, and f is the metric-enhanced parameter. At this point, the image preprocessing of the acquired image is completed.

In practical application, step 103 specifically includes: processing the first filtered images by using the threshold segmentation method based on the bilinear interpolation to determine preliminary pit defect regions; adjusting a first set parameter based on the gradient change in the current illumination environment, and screening the preliminary pit defect regions to determine a final pit defect region; performing discrete approximate Gaussian filtering on the enhanced thermal cup images to determine the filtered images; performing convolution operation on the filtered images and the second-order derivative of the Gaussian function in the y direction to determine second filtered images; adjusting a second set parameter based on the gradient change in the current illumination environment, and determining preliminary trapezoidal surface polishing print defect regions according to the second filtered images; determining the upper side polishing print defect region according to the preliminary trapezoidal surface polishing print defect regions; and determining the lower side polishing print defect region according to the thermal cup images.

In practical application, the processing the first filtered images by using the threshold segmentation method based on the bilinear interpolation to determine preliminary pit defect regions specifically includes: setting the first filtered image as a plane, searching for pixels and sub-pixels in the plane whose gray values are an adjustable set parameter t by using the threshold segmentation method based on the bilinear interpolation, and determining pixel coordinates and sub-pixel coordinates; and converting the pixel coordinates and the sub-pixel coordinates into closed contours by using a Bresenham's line algorithm; wherein the closed contour is the preliminary pit defect region.

Further, the extraction process of the preliminary pit defect region is as follows.
1) Compared with the general background region, the pit print of the thermal cup has more obvious gradient features in the y direction. In this step, convolution is performed on the image and the first-order derivative of the Gaussian function in the y direction, and the edge features of the image in the y direction are emphasized to further capture the pit region. Specifically, a parameter σ₁ needs to be predefine, and the purpose of the parameter will be explained in detail later. After acquiring the preprocessed image, the following conversion is performed on each pixel:

$${G}_{y} ( x , y ) = \frac{\partial }{\partial y} ( I ( x , y ) * G ( x , y ) ) \qquad ( 3 )$$

where * represents convolution operation, I(x,y) represents the image before conversion, G_{y}(x,y) represents the image after convolution operation, G(x,y) represents a Gaussian function, and the first-order derivative of the Gaussian function in the y direction can be expressed as:

$$\frac{\partial G ( x , y )}{\partial y} = - \frac{y}{2 π {σ}^{4}} {e}^{- \frac{{x}^{2} + {γ}^{2}}{2 {σ}^{2}}} \qquad ( 4 )$$

where σ is the standard deviation of the Gaussian function, the smaller σ is, the more sensitive it is to the edge, the sharper and more obvious the edge will be, and the image details will be preserved. Thus σ can be adjusted to different values according to the actual detection accuracy requirements.
2) After the convolution operation, a filtered image will be obtained. In order to further accurately locate the defects, the threshold segmentation method based on the bilinear interpolation is implemented for the filtered image. Specifically, a parameter t needs to be predefined, and the purpose of the parameter will be explained in detail later. The whole image is regarded as a plane. In the plane, the pixels and sub-pixels with gray value t are searched for, and their coordinates are acquired. The calculation formula of sub-pixel gray value is as follows:

$${G}^{′} ( x , y ) = ( 1 - Δ y ) \cdot {Q}_{1} + Δ \cdot {Q}_{2} \qquad ( 5 )$$

where G′(x,y) represents the sub-pixel gray value, Δy=y−y₁, where y₁ is the vertical coordinate of the pixel closest to the sub-pixel above, and the expressions of Q₁ and Q₂ are as follows:

$${Q}_{1} = ( 1 - Δ x ) \cdot I ( {x}_{1} , {y}_{1} ) + Δ x \cdot I ( {x}_{2} , {y}_{1} ) \qquad ( 6 )$$

$${Q}_{2} = ( 1 - Δ x ) \cdot I ( {x}_{1} , {y}_{1} ) + Δ x \cdot I ( {x}_{2} , {y}_{2} ) \qquad ( 7 )$$

where Δy=y−y₁, x₁ and x₂ are the horizontal coordinates of the pixels closest to the sub-pixel on the left and right, and y₂ represents the vertical coordinate of the pixel closest to the sub-pixel below.

Finally, the acquired coordinates are rounded to obtain integer coordinates, and these coordinates are converted into a closed contour by Bresenham's line algorithm. The regions enclosed by these closed contours are the preliminarily acquired pit defect regions.

In practical application, the adjusting a first set parameter based on the gradient change in the current illumination environment, and screening the preliminary pit defect regions to determine a final pit defect region, specifically includes: adjusting the first set parameter based on the gradient change in the current illumination environment; wherein the first set parameter includes a first column coordinate, a second column coordinate, a first region area, a second region area, a first region gray standard deviation and a second region gray standard deviation; and determining the preliminary pit defect region with a center column coordinate between the first column coordinate and the second column coordinate, the region between the first region area and the second region area, and the region gray standard deviation between the first region gray standard deviation and the second region gray standard deviation as a final pit defect region.

Further, the above regions will be screened by combining various features of the pit regions. Specifically, six parameters h₁, h₂, a₁, a₂, sd₁ and sd₂ need to be predefined, and the specific purpose of the parameters will be explained in detail later. After acquiring the above regions, the final pit region is obtained by screening out the region with a center column coordinate between the first column coordinate h₁ and the second column coordinate h₂, the region area between the first region area a₁ and the second region area a₂, and the region gray standard deviation between the first region gray standard deviation sd₁ and the second region gray standard deviation sd₂.

In practical application, the determining an upper side polishing print defect region according to the preliminary trapezoidal surface polishing print defect regions specifically includes: extracting upper side polishing print features of the preliminary trapezoidal surface polishing print defect regions, and determining polishing print defect region images containing the upper side polishing print features; performing mean filtering processing on the polishing print defect region images containing the upper side polishing print features to determine the polishing print defect region images subjected to mean filtering; performing convolution operation on the polishing print defect region images subjected to mean filtering and the second-order derivative of the Gaussian function in the y direction to determine convoluted polishing print defect region images; and screening the convoluted polishing print defect region image whose gray value is within the gray value range, and determining the upper side polishing print defect region.

In practical application, the extraction process of the preliminary trapezoidal surface polishing print defect region is as follows.

The features of the trapezoidal surface polishing print of the thermal cup will be further highlighted, and the features are extracted preliminarily. Specifically, two parameters k and σ₂ need to be predefined, and the specific purpose of the parameters will be explained in detail later. After the enhanced image is acquired, discrete approximate Gaussian filtering is performed, and the following conversion is performed on each pixel:

$${I}^{′} ( x , y ) = {\sum }_{i = - k}^{k} {\sum }_{j = - k}^{k} G ( i , j ) \cdot I ( x + i , y + j ) \qquad ( 8 )$$

where I′(x,y) represents the filtered image, k is the radius of the filter, and the value of k also determines the standard deviation of the Gaussian filtering G(i,j). After Gaussian filtering, convolution is performed finally on the image and the second-order derivative of the Gaussian function in they direction. The second-order derivative of the Gaussian function in the y direction can be expressed as:

$$\frac{{\partial }^{2} G ( x , y )}{\partial {y}^{2}} = \frac{{y}^{2} - {σ}_{2}^{2}}{2 {πσ}_{2}^{6}} \cdot {e}^{- \frac{{x}^{2} + {y}^{2}}{2 {σ}_{2}^{2}}} \qquad ( 9 )$$

where σ₂ is the standard deviation of the second-order derivative of the two-dimensional Gaussian function in they direction. The smaller σ₂ is, the more sensitive it is to the edge, the sharper and more obvious the edge will be, and the image details will be preserved. Thus σ₂ can be adjusted to different values according to the actual detection accuracy requirements.

Finally, the pixels in the screened and convoluted image, whose gray value are between t₁ and t₂ and whose positions are on the trapezoid surface of the thermal cup are selected as the preliminary trapezoid surface polishing print defect region.

Further, the features of the upper side polishing print of the thermal cup will be further highlighted, and the features are extracted preliminarily. Thereafter, it is taken into account that the polishing print is in the shape of a horizontal strip and the background region is rough. In order to preserve the edge features of the polishing print as much as possible and remove the interference, it is necessary to continue to perform mean filtering, where the ratio of width to height of the mean filtering window should be greater than or equal to 10:1.

After filtering, convolution is performed on the image and the second-order derivative of the Gaussian function in they direction.

The pixels which have gray values between [gₘᵢₙ,gₘₐₓ] and are located on the upper side surface of the thermal cup are screened out from the filtered image, where gₘᵢₙ and gₘₐₓ represent the lower and upper gray thresholds for screening, respectively. By adjusting these two thresholds, the polishing print with specified features can be screened to meet different product requirements. Each region consisted of screened pixels is regarded as a polishing print region.

In practical application, the determining the lower side polishing print defect region according to the thermal cup images specifically includes: stretching the thermal cup images to determine the stretched thermal cup images; performing the discrete approximate Gaussian filtering on the stretched thermal cup images to determine the thermal cup images subjected to Gaussian filtering; performing convolution operation on the thermal cup images subjected to Gaussian filtering and a first-order derivative of the Gaussian function in the y direction to determine the convolved thermal cup images; and screening out the convolved thermal cup image whose gray value is within the gray value range, and determining the lower side polishing print defect region.

Further, the features of the lower side polishing print of the thermal cup will be further highlighted, and the features are extracted preliminarily. Specifically, this step first acquires the original image of the camera obtained in the first step, rather than the enhanced image obtained in the second step. Thereafter, the gray value range of the image is stretched to [0, 255] to improve the contrast between the lower side background region and the polishing print. The stretching operation is as follows:

$${I}^{′} = I * M + A \qquad ( 10 )$$

where I′ represents the pixel after conversion, I represents the pixel before conversion, M is the stretching parameter, and A is the conversion parameter. The stretching parameter M can be determined by the following formula:

$$M = \frac{255}{{I}_{max} - {I}_{min}} \qquad ( 11 )$$

where Iₘₐₓ represents the maximum gray value of the image before conversion, and Iₘᵢₙ represents the minimum gray value of the image before conversion. The stretching parameter A can be determined by the following formula:

$$A = - M * {I}_{min} \qquad ( 12 )$$

After stretching the image, it is necessary to perform discrete approximate Gaussian filtering on the image, and then perform convolution operation on the filtered image and the first-order derivative of the Gaussian function in they direction.

After the above operations, the pixels which have gray values between [gₘᵢₙ₂, gₘₐₓ₂] and are located on the lower side surface of the thermal cup are screened out, where gₘᵢₙ₂ and gₘₐₓ₂ represent the lower and upper gray thresholds for screening, respectively. By adjusting these two thresholds, the polishing print with specified features can be screened to meet different product requirements. Each region consisted of screened pixels is regarded as a polishing print region.

It is not easy to observe the polishing print and the pit defect. The traditional manual detection is inefficient and inaccurate. Considering the existence of shallow polishing prints and shallow pits, such defects are not obvious in the shot pictures, and the edge gray value changes little. Therefore, it is not easy to detect the defects using the actual visual detection algorithm. In the present disclosure, the contrast is enhanced through image preprocessing; the detection accuracy is improved and the defects are accurately located by using the bilinear interpolation sub-pixel method; convolution operation is performed on the image by using the first-order derivative and the second-order derivative of the Gaussian function in the y direction to amplify the defect features for edge detection, so that the information such as the gradient and the gray standard deviation of pits and polishing print defects can be made full use, and the defects can be detected more easily, which is high in efficiency, low in missed detection rate and low in false detection rate. The production efficiency can be greatly improved.

At the same time, in the process of product switching, the defect identification algorithm can keep a relatively stable detection effect, and only the adjustable parameters in the above method need to be adjusted according to the gradient change information of the current product in the current illumination environment. The specific defects are also kept or the sensitivity to defects is reduced according to production requirements, thus ensuring the yield of products.

### Embodiment 2

In order to implement the method corresponding to the Embodiment 1 and implement the corresponding functions and technical effects, a system for detecting a surface defect of a thermal cup is provided hereinafter.

A system for detecting a surface defect of a thermal cup includes:
a preprocessing module, configured to acquire thermal cup images from different angles, and preprocess the thermal cup images to generate enhanced thermal cup images;
a convolution module, configured to perform convolution operation on the enhanced thermal cup images and a first-order derivative of a Gaussian function in the y direction to determine first filtered images; and
a defect region determining module, configured to adjust set parameters based on a gradient change in the current illumination environment, and determine defect regions according to the first filtered images and the thermal cup images by using a threshold segmentation method based on a bilinear interpolation and a second-order derivative of the Gaussian function in the y direction; wherein the defect regions include a final pit defect region, an upper side polishing print defect region and a lower side polishing print defect region.

### Embodiment 3

An electronic device is provided, including a memory, a processor, and a computer program stored on the memory, wherein the computer program, when executed by the processor, causes the electronic device to executes the method for detecting a surface defect of the thermal cup above.

A computer-readable storage medium having a computer program stored therein is provided, wherein the computer program, when executed by a processor, implements the method for detecting a surface defect of the thermal cup above.

In this specification, various embodiments are described in a progressive way. The differences between each embodiment and other embodiments are highlighted, and the same and similar parts of various embodiments can be referred to each other. Since the system disclosed in the embodiment corresponds to the method disclosed in the embodiment, the system is described simply. Refer to the description of the method for the relevant points.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the detailed description and application scope for those skilled in the art. To sum up, the contents of the specification should not be construed as limiting the present disclosure.

What is claimed is:

1. A method for detecting a surface defect of a thermal cup, comprising:
acquiring thermal cup images from different angles, and preprocessing the thermal cup images to generate enhanced thermal cup images;
performing convolution operation on the enhanced thermal cup images and a first-order derivative of a Gaussian function in a y direction to determine first filtered images; and
adjusting set parameters based on a gradient change in current illumination environment, and determining defect regions according to the first filtered images and the thermal cup images by using a threshold segmentation method based on a bilinear interpolation and a second-order derivative of the Gaussian function in they direction; wherein the defect regions comprise a final pit defect region, an upper side polishing print defect region and a lower side polishing print defect region.

2. The method according to claim 1, wherein the preprocessing the thermal cup images to generate enhanced thermal cup images comprises:
determining stretching of different brightness regions of the thermal cup images according to an adjustable gamma correction parameter, enhancing contrast between pixels in a gray scale range, and determining the thermal cup images subjected to gamma conversion; and
filtering the thermal cup images subjected to gamma conversion according to an adjustable contrast enhancement parameter to generate the enhanced thermal cup images.

3. The method according to claim 1, wherein the adjusting set parameters based on a gradient change in current illumination environment, and determining defect regions according to the first filtered images and the thermal cup images by using a threshold segmentation method based on a bilinear interpolation and a second-order derivative of the Gaussian function in the y direction, comprises:
processing the first filtered images by using the threshold segmentation method based on the bilinear interpolation to determine preliminary pit defect regions;
adjusting a first set parameter based on the gradient change in the current illumination environment, and screening the preliminary pit defect regions to determine a final pit defect region;
performing discrete approximate Gaussian filtering on the enhanced thermal cup images to determine filtered images;
performing convolution operation on the filtered images and the second-order derivative of the Gaussian function in the y direction to determine second filtered images;
adjusting a second set parameter based on the gradient change in the current illumination environment, and determining preliminary trapezoidal surface polishing print defect regions according to the second filtered images;
determining the upper side polishing print defect region according to the preliminary trapezoidal surface polishing print defect regions; and
determining the lower side polishing print defect region according to the thermal cup images.

4. The method according to claim 3, wherein the processing the first filtered images by using the threshold segmentation method based on the bilinear interpolation to determine preliminary pit defect regions comprises:
setting the first filtered image as a plane, searching for pixels and sub-pixels in the plane whose gray values are an adjustable set parameter t by using the threshold segmentation method based on the bilinear interpolation, and determining pixel coordinates and sub-pixel coordinates; and
converting the pixel coordinates and the sub-pixel coordinates into closed contours by using a Bresenham's line algorithm; wherein each closed contour is a preliminary pit defect region.

5. The method according to claim 4, wherein the adjusting a first set parameter based on the gradient change in the current illumination environment, and screening the preliminary pit defect regions to determine a final pit defect region, comprises:
adjusting the first set parameter based on the gradient change in the current illumination environment; wherein the first set parameter comprises a first column coordinate, a second column coordinate, a first region area, a second region area, a first region gray standard deviation and a second region gray standard deviation; and
determining the preliminary pit defect region with a center column coordinate between the first column coordinate and the second column coordinate, a region area between the first region area and the second region area, and a region gray standard deviation between the first region gray standard deviation and the second region gray standard deviation as the final pit defect region.

6. The method according to claim 3, wherein the determining the upper side polishing print defect region according to the preliminary trapezoidal surface polishing print defect regions comprises:
extracting upper side polishing print features of the preliminary trapezoidal surface polishing print defect regions, and determining polishing print defect region images containing the upper side polishing print features;
performing mean filtering processing on the polishing print defect region images containing the upper side polishing print features to determine the polishing print defect region images subjected to mean filtering;
performing convolution operation on the polishing print defect region images subjected to mean filtering and the second-order derivative of the Gaussian function in the y direction to determine convoluted polishing print defect region images; and
screening a convoluted polishing print defect region image whose gray value is within a gray value range, and determining the upper side polishing print defect region.

7. The method according to claim 3, wherein the determining the lower side polishing print defect region according to the thermal cup images comprises:
stretching the thermal cup images to determine stretched thermal cup images;
performing the discrete approximate Gaussian filtering on the stretched thermal cup images to determine the thermal cup images subjected to Gaussian filtering;
performing the convolution operation on the thermal cup images subjected to Gaussian filtering and the first-order derivative of the Gaussian function in the y direction to determine convolved thermal cup images; and
screening out a convolved thermal cup image whose gray value is within a gray value range, and determining the lower side polishing print defect region.

8. A system for detecting a surface defect of a thermal cup, comprising:
a preprocessing module, configured to acquire thermal cup images from different angles, and preprocess the thermal cup images to generate enhanced thermal cup images;
a convolution module, configured to perform convolution operation on the enhanced thermal cup images and a first-order derivative of a Gaussian function in a y direction to determine first filtered images; and
a defect region determining module, configured to adjust set parameters based on a gradient change in current illumination environment, and determine defect regions according to the first filtered images and the thermal cup images by using a threshold segmentation method based on a bilinear interpolation and a second-order derivative of the Gaussian function in the y direction;
wherein the defect regions comprise a final pit defect region, an upper side polishing print defect region and a lower side polishing print defect region.

9. An electronic device, comprising:
a memory,
a processor, and
a computer program, stored on the memory, wherein the computer program, when executed by the processor, causes the electronic device to perform the method for detecting the surface defect of the thermal cup according to claim 1.

10. The electronic device according to claim 9, wherein the preprocessing the thermal cup images to generate enhanced thermal cup images comprises:
determining stretching of different brightness regions of the thermal cup images according to an adjustable gamma correction parameter, enhancing contrast between pixels in a gray scale range, and determining the thermal cup images subjected to gamma conversion; and
filtering the thermal cup images subjected to gamma conversion according to an adjustable contrast enhancement parameter to generate the enhanced thermal cup images.

11. The electronic device according to claim 9, wherein the adjusting set parameters based on a gradient change in current illumination environment, and determining defect regions according to the first filtered images and the thermal cup images by using a threshold segmentation method based on a bilinear interpolation and a second-order derivative of the Gaussian function in they direction, comprises:
processing the first filtered images by using the threshold segmentation method based on the bilinear interpolation to determine preliminary pit defect regions;
adjusting a first set parameter based on the gradient change in the current illumination environment, and screening the preliminary pit defect regions to determine a final pit defect region;
performing discrete approximate Gaussian filtering on the enhanced thermal cup images to determine filtered images;
performing convolution operation on the filtered images and the second-order derivative of the Gaussian function in the y direction to determine second filtered images;
adjusting a second set parameter based on the gradient change in the current illumination environment, and determining preliminary trapezoidal surface polishing print defect regions according to the second filtered images;
determining the upper side polishing print defect region according to the preliminary trapezoidal surface polishing print defect regions; and
determining the lower side polishing print defect region according to the thermal cup images.

12. The electronic device according to claim 11, wherein the processing the first filtered images by using the threshold segmentation method based on the bilinear interpolation to determine preliminary pit defect regions comprises:
setting the first filtered image as a plane, searching for pixels and sub-pixels in the plane whose gray values are an adjustable set parameter t by using the threshold segmentation method based on the bilinear interpolation, and determining pixel coordinates and sub-pixel coordinates; and
converting the pixel coordinates and the sub-pixel coordinates into closed contours by using a Bresenham's line algorithm; wherein each closed contour is a preliminary pit defect region.

13. The electronic device according to claim 12, wherein the adjusting a first set parameter based on the gradient change in the current illumination environment, and screening the preliminary pit defect regions to determine a final pit defect region, comprises:
adjusting the first set parameter based on the gradient change in the current illumination environment; wherein the first set parameter comprises a first column coordinate, a second column coordinate, a first region area, a second region area, a first region gray standard deviation and a second region gray standard deviation; and
determining the preliminary pit defect region with a center column coordinate between the first column coordinate and the second column coordinate, a region area between the first region area and the second region area, and a region gray standard deviation between the first region gray standard deviation and the second region gray standard deviation as the final pit defect region.

14. The electronic device according to claim 11, wherein the determining the upper side polishing print defect region according to the preliminary trapezoidal surface polishing print defect regions comprises:
extracting upper side polishing print features of the preliminary trapezoidal surface polishing print defect regions, and determining polishing print defect region images containing the upper side polishing print features;
performing mean filtering processing on the polishing print defect region images containing the upper side polishing print features to determine the polishing print defect region images subjected to mean filtering;
performing convolution operation on the polishing print defect region images subjected to mean filtering and the second-order derivative of the Gaussian function in the y direction to determine convoluted polishing print defect region images; and
screening a convoluted polishing print defect region image whose gray value is within a gray value range, and determining the upper side polishing print defect region.

15. The electronic device according to claim 11, wherein the determining the lower side polishing print defect region according to the thermal cup images comprises:
stretching the thermal cup images to determine stretched thermal cup images;
performing the discrete approximate Gaussian filtering on the stretched thermal cup images to determine the thermal cup images subjected to Gaussian filtering;
performing the convolution operation on the thermal cup images subjected to Gaussian filtering and the first-order derivative of the Gaussian function in the y direction to determine convolved thermal cup images; and
screening out a convolved thermal cup image whose gray value is within a gray value range, and determining the lower side polishing print defect region.

16. A non-transitory computer-readable storage medium having a computer program stored therein, wherein the computer program, when executed by a processor, implements the method for detecting the surface defect of the thermal cup according to claim 1.

17. The non-transitory computer-readable storage medium according to claim 16, wherein the preprocessing the thermal cup images to generate enhanced thermal cup images comprises:
determining stretching of different brightness regions of the thermal cup images according to an adjustable gamma correction parameter, enhancing contrast between pixels in a gray scale range, and determining the thermal cup images subjected to gamma conversion; and
filtering the thermal cup images subjected to gamma conversion according to an adjustable contrast enhancement parameter to generate the enhanced thermal cup images.

18. The non-transitory computer-readable storage medium according to claim 16, wherein the adjusting set parameters based on a gradient change in current illumination environment, and determining defect regions according to the first filtered images and the thermal cup images by using a threshold segmentation method based on a bilinear interpolation and a second-order derivative of the Gaussian function in they direction, comprises:
processing the first filtered images by using the threshold segmentation method based on the bilinear interpolation to determine preliminary pit defect regions;
adjusting a first set parameter based on the gradient change in the current illumination environment, and screening the preliminary pit defect regions to determine a final pit defect region;
performing discrete approximate Gaussian filtering on the enhanced thermal cup images to determine filtered images;
performing convolution operation on the filtered images and the second-order derivative of the Gaussian function in the y direction to determine second filtered images;
adjusting a second set parameter based on the gradient change in the current illumination environment, and determining preliminary trapezoidal surface polishing print defect regions according to the second filtered images;
determining the upper side polishing print defect region according to the preliminary trapezoidal surface polishing print defect regions; and
determining the lower side polishing print defect region according to the thermal cup images.

19. The non-transitory computer-readable storage medium according to claim 18, wherein the processing the first filtered images by using the threshold segmentation method based on the bilinear interpolation to determine preliminary pit defect regions comprises:
setting the first filtered image as a plane, searching for pixels and sub-pixels in the plane whose gray values are an adjustable set parameter t by using the threshold segmentation method based on the bilinear interpolation, and determining pixel coordinates and sub-pixel coordinates; and
converting the pixel coordinates and the sub-pixel coordinates into closed contours by using a Bresenham's line algorithm; wherein each closed contour is a preliminary pit defect region.

20. The non-transitory computer-readable storage medium according to claim 19, wherein the adjusting a first set parameter based on the gradient change in the current illumination environment, and screening the preliminary pit defect regions to determine a final pit defect region, comprises:
adjusting the first set parameter based on the gradient change in the current illumination environment; wherein the first set parameter comprises a first column coordinate, a second column coordinate, a first region area, a second region area, a first region gray standard deviation and a second region gray standard deviation; and
determining the preliminary pit defect region with a center column coordinate between the first column coordinate and the second column coordinate, a region area between the first region area and the second region area, and a region gray standard deviation between the first region gray standard deviation and the second region gray standard deviation as the final pit defect region.
